(19) United States
(12) Patent Application Publication
(10) Pub. No.: US 2018/0096261 A1
(43) Pub. Date: Apr. 5, 2018

(54) UNSUPERVISED MACHINE LEARNING ENSEMBLE FOR ANOMALY DETECTION

(71) Applicant: Intel Corporation, Santa Clara, CA (US)

(72) Inventors: Hong-Min Chu, Taipei (TW); Yu-Lin Tsou, New Taipei City (TW); Shao-Wen Yang, San Jose, CA (US)

(73) Assignee: Intel Corporation, Santa Clara, CA (US)

(21) Appl. No.: 15/283,308

(22) Filed: Oct. 1, 2016

(51) Int. Cl. G06N 99/00

(52) U.S. Cl. CPC G06N 99/005

(57) ABSTRACT

An anomaly detection model generator accesses sensor data generated by a plurality of sensors, determines a plurality of feature vectors from the sensor data, and executes a plurality of unsupervised anomaly detection machine learning algorithms in an ensemble using the plurality of feature vectors to generate a set of predictions. Respective entropy-based weightings are determined for each of the plurality of unsupervised anomaly detection machine learning algorithms from the set of predictions. A set of pseudo labels is generated based on the predictions and weightings, and a supervised machine learning algorithm uses the set of pseudo labels as training data to generate an anomaly detection model corresponding to the plurality of sensors.

### TECHNICAL FIELD

This disclosure relates in general to the field of computer systems and, more particularly, to managing machine-to-machine systems.

### BACKGROUND

The Internet has enabled interconnection of different computer networks all over the world. While previously, Internet-connectivity was limited to conventional general purpose computing systems, ever increasing numbers and types of products are being redesigned to accommodate connectivity with other devices over computer networks, including the Internet. For example, smart phones, tablet computers, wearables, and other mobile computing devices have become very popular, even supplanting larger, more traditional general purpose computing devices, such as traditional desktop computers in recent years. Increasingly, tasks traditionally performed on a general purpose computers are performed using mobile computing devices with smaller form factors and more constrained features sets and operating systems. Further, traditional appliances and devices are becoming “smarter” as they are ubiquitous and equipped with functionality to connect to or consume content from the Internet. For instance, devices, such as televisions, gaming systems, household appliances, thermostats, automobiles, watches, have been outfitted with network adapters to allow the devices to connect with the Internet (or another device) either directly or through a connection with another computer connected to the network. Additionally, this increasing universe of interconnected devices has also facilitated an increase in computer-controlled sensors that are likewise interconnected and collecting new and large sets of data. The interconnection of an increasingly large number of devices, or “things,” is believed to foreshadow an era of advanced automation and interconnectivity, referred to, sometimes, as the Internet of Things (IoT).

### BRIEF DESCRIPTION OF THE DRAWINGS

FIG. 1A illustrates an embodiment of a system including multiple sensor devices and an example management system.

FIG. 1B illustrates an embodiment of a cloud computing network.

FIG. 2 illustrates an embodiment of a system including an example management system.

FIG. 3 is a simplified flow diagram illustrating an example generation of an anomaly detection model.

FIG. 4 is a simplified flow diagram illustrating an example generation of anomaly labels for use in generating an anomaly detection model.

FIG. 5 is a simplified block diagram illustrating examples of the generation and use of anomaly detection models.

FIG. 6 is a flowchart illustrating an example technique for generating an anomaly detection model using an ensemble of unsupervised machine learning algorithms.

FIG. 7 is a block diagram of an exemplary processor in accordance with one embodiment; and

FIG. 8 is a block diagram of an exemplary computing system in accordance with one embodiment.

Like reference numbers and designations in the various drawings indicate like elements.

### DETAILED DESCRIPTION OF EXAMPLE EMBODIMENTS

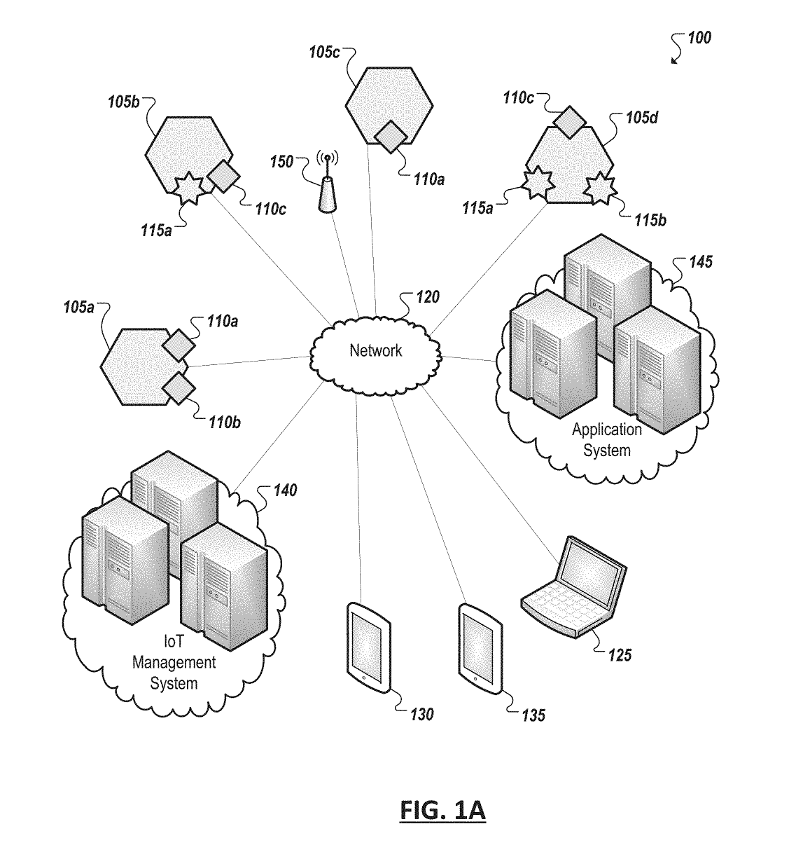

FIG. 1A is a block diagram illustrating a simplified representation of a system 100 that includes one or more devices 105a-d, or assets, deployed throughout an environment. Each device 105a-d may include a computer processor and/or communications module to allow each device 105a-d to interoperate with one or more other devices (e.g., 105a-d) or systems in the environment. Each device can further include one or more instances of various types of sensors (e.g., 110a-c), actuators (e.g., 115a-b), storage, power, computer processing, and communication functionality which can be leveraged and utilized (e.g., by other devices or software) within a machine-to-machine, or Internet of Things (IoT) system or application. In some cases, inter-device communication and even deployment of an IoT application may be facilitated by one or more gateway devices (e.g., 150) through which one or more of the devices (e.g., 105a-d) communicate and gain access to other devices and systems in one or more networks (e.g., 120).

Sensors, or sensor assets, are capable of detecting, measuring, and generating sensor data describing characteristics of the environment in which they reside, are mounted, or are in contact with. For instance, a given sensor (e.g., 110a-c) may be configured to detect one or more respective characteristics such as movement, weight, physical contact, temperature, wind, noise, light, computer communications, wireless signals, position, humidity, the presence of radiation, liquid, or specific chemical compounds, among several other examples. Indeed, sensors (e.g., 110a-c) as described herein, anticipate the development of a potentially limitless universe of various sensors, each designed to and capable of detecting, and generating corresponding sensor data for, new and known environmental characteristics. Actuators (e.g., 115a-b) can allow the device to perform some kind of action to affect its environment. For instance, one or more of the devices (e.g., 105b,d) may include one or more respective actuators that accepts an input and perform its respective action in response. Actuators can include controllers to activate additional functionality, such as an actuator to selectively toggle the power or operation of an alarm, camera (or other sensors), heating, ventilation, and air conditioning (HVAC) appliance, household appliance, in-vehicle device, lighting, among other examples.

In some implementations, sensors 110a-c and actuators 115a-b provided on devices 105a-d can be assets incorporated in and/or forming an Internet of Things (IoT) or machine-to-machine (M2M) system. IoT systems can refer to new or improved ad-hoc systems and networks composed of multiple different devices interoperating and synergizing to deliver one or more results or deliverables. Such ad-hoc systems are emerging as more and more products and equipment evolve to become “smart” in that they are controlled or monitored by computing processors and provided with facilities to communicate, through computer-implemented mechanisms, with other computing devices (and products having network communication capabilities). For instance, IoT systems can include networks built from sensors and communication modules integrated in or attached to “things” such as equipment, toys, tools, vehicles, etc. and even living things (e.g., plants, animals, humans, etc.). In some instances, an IoT system can develop organically or unexpectedly, with a collection of sensors monitoring a variety of things and related environments and interconnecting with data analytics systems and/or systems controlling one or more other smart devices to enable various use cases and application, including previously unknown use cases. Further, IoT systems can be formed from devices that hitherto had no contact with each other, with the system being composed and automatically configured spontaneously or on the fly (e.g., in accordance with an IoT application defining or controlling the interactions). Further, IoT systems can often be composed of a complex and diverse collection of connected devices (e.g., 105a-d), such as devices sourced or controlled by varied groups of entities and employing varied hardware, operating systems, software applications, and technologies. In some cases, a gateway (e.g., 150) may be provided to localize a particular IoT system, with the gateway 150 able to detect nearby devices (e.g., 105a-d) and deploy (e.g., in an automated, impromptu manner) an instance of a particular IoT application by orchestrating configuration of these detected devices to satisfy requirements of the particular IoT application, among other examples.

Facilitating the successful interoperability of such diverse systems is, among other example considerations, an important issue when building or defining an IoT system. Software applications can be developed to govern how a collection of IoT devices can interact to achieve a particular goal or service. In some cases, the IoT devices may not have been originally built or intended to participate in such a service or in cooperation with one or more other types of IoT devices. Indeed, part of the promise of the Internet of Things is that innovators in many fields will dream up new applications involving diverse groupings of the IoT devices as such devices become more commonplace and new “smart” or “connected” devices emerge. However, the act of programming, or coding, such IoT applications may be unfamiliar to many of these potential innovators, thereby limiting the ability of these new applications to be developed and come to market, among other examples and issues.

As shown in the example of FIG. 1A, multiple IoT devices (e.g., 105a-d) can be provided from which one or more different IoT application deployments can be built. For instance, a device (e.g., 105a-d) can include such examples as a mobile personal computing device, such as a smart phone or tablet device, a wearable computing device (e.g., a smart watch, smart garment, smart glasses, smart helmet, headset, etc.), purpose-built devices such as and less conventional computer-enhanced products such as home, building, vehicle automation devices (e.g., smart heat-ventilation-air-conditioning (HVAC) controllers and sensors, light detection and controls, energy management tools, etc.), smart appliances (e.g., smart televisions, smart refrigerators, etc.), and other examples. Some devices can be purpose-built to host sensor and/or actuator resources, such as a weather sensor devices that include multiple sensors related to weather monitoring (e.g., temperature, wind, humidity sensors, etc.), traffic sensors and controllers, among many other examples. Some devices may be statically located, such as a device mounted within a building, on a lamppost, sign, water tower, secured to a floor (e.g., indoor or outdoor), or other fixed or static structure. Other devices may be mobile, such as a sensor provisioned in the interior or exterior of a vehicle, in-package sensors (e.g., for tracking cargo), wearable devices worn by active human or animal users, an aerial, ground-based, or underwater drone among other examples. Indeed, it may be desired that some sensors move within an environment and applications can be built around use cases involving a moving subject or changing environment using such devices, including use cases involving both moving and static devices, among other examples.

Continuing with the example of FIG. 1A, software-based IoT management platforms can be provided to allow developers and end users to build and configure IoT applications and systems. An IoT application can provide software support to organize and manage the operation of a set of IoT devices for a particular purpose or use case. In some cases, an IoT application can be embodied as an application on an operating system of a user computing device (e.g., 125), a mobile app for execution on a smart phone, tablet, smart watch, or other mobile device (e.g., 130, 135), a remote server, and/or gateway device (e.g., 150). In some cases, the application can have or make use of an application management utility allowing users to configure settings and policies to govern how the set devices (e.g., 105a-d) are to operate within the context of the application. A management utility can also be used to orchestrate the deployment of a particular instance of an IoT application, including the automated selection and configuration of devices (and their assets) that are to be used with the application.

A management utility may also manage faults, outages, errors, and other anomalies detected on the various devices within an IoT application deployment. Anomalies may be reported to the management utility, for instance, by the IoT devices as they determine such anomalies. A management utility may additionally assist IoT devices with anomaly detection. Devices may utilize machine-learning-based anomaly detection models, which may be provided or developed with assistance of a management utility, among other examples. Anomaly detection models may be deployed locally at the devices, to allow devices to self-detect anomalies in data generated by sensors on the device. Gateways (e.g., 150) may also or alternatively host and consume anomaly detection models (e.g., generated by an anomaly management) to detect anomalies occurring in data generated by any devices connected to the gateway. In still other examples, a management utility (e.g., of management system 140) may utilize anomaly detection models. Such anomaly detection models, in some implementations, may be generated from an ensemble of machine learning algorithms used to automate generation of labels based on data generated by one or more of the devices (e.g., 105a-d) and utilize these labels to generate a corresponding anomaly detection model through a supervised machine learning algorithm system utilizing the generated labels, among other examples.

In some cases, an IoT management application, anomaly detection logic, and/or model generation logic, may be provided (e.g., on a gateway, user device, or cloud-based server, etc.), which can manage potentially multiple different IoT applications or systems. For instance, an IoT management application, or system, may be hosted on a single system, such as a single server system (e.g., 140), a single end-user device (e.g., 125, 130, 135), or a single gateway device (e.g., 150), among other examples. Alternatively, an IoT management system, or other system, may be implemented to be distributed across multiple hosting devices (e.g., 125, 130, 135, 140, 150, etc.).

As noted above, IoT applications may be localized, such that a service is implemented utilizing an IoT system (e.g., of devices 105a-d) within a specific geographic area, room, or location. In some instances, IoT devices (e.g., 105a-d) may connect to one or more gateway devices (e.g., 150) on which a portion of management functionality (e.g., as shared with or supported by management system 140) and a portion of application service functionality (e.g., as shared with or supported by application system 145). Service logic and configuration data may be pushed (or pulled) to the gateway device 150 and used to configure IoT devices (e.g., 105a-d, 130, 135, etc.) within range or proximity of the gateway device 150 to allow the set of devices to implement a particular service within that location. Likewise, anomaly detection models generated for one or more components or sub-systems of a system may be distributed (e.g., to or through a gateway 150) for local consumption, among other examples. A gateway device (e.g., 150) may be implemented as a dedicated gateway element, or may be a multi-purpose or general purpose device, such as another IoT device (similar to devices 105a-d) or user device (e.g., 125, 130, 135) that itself may include sensors and/or actuators to perform tasks within an IoT system, among other examples.

In some cases, IoT systems can interface (through a corresponding IoT management system or application or one or more of the participating IoT devices) with remote services, such as data storage, information services (e.g., media services, weather services), geolocation services, and computational services (e.g., data analytics, search, diagnostics, etc.) hosted in cloud-based and other remote systems (e.g., 140, 145). For instance, the IoT system can connect (e.g., directly or through a gateway 150) to a remote service (e.g., 145) over one or more networks 120. In some cases, the remote service can, itself, be considered an asset of an IoT application. Data received by a remotely-hosted service can be consumed by the governing IoT application and/or one or more of the component IoT devices to cause one or more results or actions to be performed, among other examples. The one or more networks (e.g., 120) can facilitate communication between sensor devices (e.g., 105a-d), end user devices (e.g., 123, 130, 135), gateways (e.g., 150), and other systems (e.g., 140, 145) utilized to implement and manage IoT applications in an environment. Such networks can include wired and/or wireless local networks, public networks, wide area networks, broadband cellular networks, the Internet, and the like.

In general, “servers,” “clients,” “computing devices,” “network elements,” “hosts,” “system-type system entities,” “user devices,” “gateways,” “IoT devices,” “sensor devices,” and “systems” (e.g., 105a-d, 125, 130, 135, 140, 145, 150, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing apparatus. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

While FIG. 1A is described as containing or being associated with a plurality of elements, not all elements illustrated within computing environment 100 of FIG. 1A may be utilized in each alternative implementation of the present disclosure. Additionally, one or more of the elements described in connection with the examples of FIG. 1A may be located external to computing environment 100, while in other instances, certain elements may be included within or as a portion of one or more of the other described elements, as well as other elements not described in the illustrated implementation. Further, certain elements illustrated in FIG. 1A may be combined with other components, as well as used for alternative or additional purposes in addition to those purposes described herein.

As noted above, a collection of devices, or endpoints, may participate in Internet-of-things (IoT) networking, which may utilize wireless local area networks (WLAN), such as those standardized under IEEE 802.11 family of standards, home-area networks such as those standardized under the Zigbee Alliance, personal-area networks such as those standardized by the Bluetooth Special Interest Group, cellular data networks, such as those standardized by the Third-Generation Partnership Project (3GPP), and other types of networks, having wireless, or wired, connectivity. For example, an endpoint device may also achieve connectivity to a secure domain through a bus interface, such as a universal serial bus (USB)-type connection, a High-Definition Multimedia Interface (HDMI), or the like.

As shown in the simplified block diagram 101 of FIG. 1B, in some instances, a cloud computing network, or cloud, in communication with a mesh network of IoT devices (e.g., 105a-d), which may be termed a “fog,” may be operating at the edge of the cloud. To simplify the diagram, not every IoT device 105 is labeled.

The fog 170 may be considered to be a massively interconnected network wherein a number of IoT devices 105 are in communications with each other, for example, by radio links 165. This may be performed using the open interconnect consortium (OIC) standard specification 1.0 released by the Open Connectivity Foundation™ (OCF) on Dec. 23, 2015. This standard allows devices to discover each other and establish communications for interconnects. Other interconnection protocols may also be used, including, for example, the optimized link state routing (OLSR) Protocol, or the better approach to mobile ad-hoc networking (B.A.T.M.A.N.), among others.

Three types of IoT devices 105 are shown in this example, gateways 150, data aggregators 175, and sensors 180, although any combinations of IoT devices 105 and functionality may be used. The gateways 150 may be edge devices that provide communications between the cloud 160 and the fog 170, and may also function as charging and locating devices for the sensors 180. The data aggregators 175 may provide charging for sensors 180 and may also locate the sensors 180. The locations, charging alerts, battery alerts, and other data, or both may be passed along to the cloud 160 through the gateways 150. As described herein, the sensors 180 may provide power, location services, or both to other devices or items.

Communications from any IoT device 105 may be passed along the most convenient path between any of the IoT devices 105 to reach the gateways 150. In these networks, the number of interconnections provide substantial redundancy, allowing communications to be maintained, even with the loss of a number of IoT devices 105.

The fog 170 of these IoT devices 105 devices may be presented to devices in the cloud 160, such as a server 145, as a single device located at the edge of the cloud 160, e.g., a fog 170 device. In this example, the alerts coming from the fog 170 device may be sent without being identified as coming from a specific IoT device 105 within the fog 170. For example, an alert may indicate that a sensor 180 needs to be returned for charging and the location of the sensor 180, without identifying any specific data aggregator 175 that sent the alert.

In some examples, the IoT devices 105 may be configured using an imperative programming style, e.g., with each IoT device 105 having a specific function. However, the IoT devices 105 forming the fog 170 may be configured in a declarative programming style, allowing the IoT devices 105 to reconfigure their operations and determine needed resources in response to conditions, queries, and device failures. Corresponding service logic may be provided to dictate how devices may be configured to generate ad hoc assemblies of devices, including assemblies of devices which function logically as a single device, among other examples. For example, a query from a user located at a server 145 about the location of a sensor 180 may result in the fog 170 device selecting the IoT devices 105, such as particular data aggregators 175, needed to answer the query. If the sensors 180 are providing power to a device, sensors associated with the sensor 180, such as power demand, temperature, and the like, may be used in concert with sensors on the device, or other devices, to answer a query. In this example, IoT devices 105 in the fog 170 may select the sensors on particular sensor 180 based on the query, such as adding data from power sensors or temperature sensors. Further, if some of the IoT devices 105 are not operational, for example, if a data aggregator 175 has failed, other IoT devices 105 in the fog 170 device may provide substitute, allowing locations to be determined.

Further, the fog 170 may divide itself into smaller units based on the relative physical locations of the sensors 180 and data aggregators 175. In this example, the communications for a sensor 180 that has been instantiated in one portion of the fog 170 may be passed along to IoT devices 105 along the path of movement of the sensor 180. Further, if the sensor 180 is moved from one location to another location that is in a different region of the fog 170, different data aggregators 175 may be identified as charging stations for the sensor 180.

As an example, if a sensor 180 is used to power a portable device in a chemical plant, such as a personal hydrocarbon detector, the device will be moved from an initial location, such as a stockroom or control room, to locations in the chemical plant, which may be a few hundred feet to several thousands of feet from the initial location. If the entire facility is included in a single fog 170 charging structure, as the device moves, data may be exchanged between data aggregators 175 that includes the alert and location functions for the sensor 180, e.g., the instantiation information for the sensor 180. Thus, if a battery alert for the sensor 180 indicates that it needs to be charged, the fog 170 may indicate a closest data aggregator 175 that has a fully charged sensor 180 ready for exchange with the sensor 180 in the portable device.

With the emergence of Internet of Things (IoT) system, it is anticipated that over 50 billion devices will be available to be interconnected by the year 2020, potentially enabling enormous and world-changing opportunities in terms of technology breakthrough and business development. For instance, in home automation systems, automation of a home is typically increased as more IoT devices are added for use in sensing and controlling additional aspects of the home. However, as the number and variety of devices increase, the management of “things” (or devices for inclusion in IoT systems) becomes outstandingly complex and challenging.

One of the major obstacles preventing the adoption of IoT systems is the reality that many of the various (and sometimes special purpose) IoT devices may be rather unreliable in the following aspects.
Some devices are to be operated in harsh environments. Sensor readings can drift in extreme environments, e.g., at 120 degree Fahrenheit, in a rainy day, etc.;
Devices may be per se unreliable. Many IoT devices are designed for consumers, which may imply lower cost, lower durability, and lower overall reliability;
Some devices run on unreliable power sources. Many IoT devices, to preserve their mobility and flexibility of deployment, utilize battery power (e.g., in the absence of a convenient or consistent wired power source), leading to reliance on battery lifespan for reliably device performance;
Unreliable network connectivity. As many IoT devices may be deployed beyond the reach of a wired network connection, wireless network connectivity is relied upon, which may sometimes be unreliable and intermittent; among other examples.

All of the above issues may lead to unpredictable or anomalous sensor readings, e.g., value drifting, random value, null value, etc., which hereinafter may be referred to as “anomalies” or “outliers”.

A system may be provided with functionality to allow anomalies to be identified to prevent negative effects on certain IoT deployments and detect error-prone devices or particular sensor or actuators of these devices. Anomaly detection may trigger service events to prompt a machine or humans to take action in response to the anomalies. In some implementations, data recovery or replacement may be orchestrated in response to determining an anomaly in a received sensor reading. Further, where sensor redundancy is available in a system (e.g., an IoT deployment), anomaly detection may trigger the replacement of the device or sensor producing the anomaly with another device if it is determined that the anomaly corresponds to an error in the device or sensor to be replaced. In some implementations, anomaly detection may be carried out at the device, allowing the device itself to determine an anomaly. As noted above, anomaly detection models may be developed for a variety of devices, sensors, and even combinations of devices/sensors. Logic may be provided in the devices themselves, in gateways through which a device may communicate, or in a backend service (e.g., a managements system) to consume an anomaly detection model and detect anomalies appearing in data generated by the corresponding device, sensor, or group of sensor devices. In the case of the detection logic being included in a backend server, anomaly detection based on an anomaly detection model may be provided to a device (and corresponding IoT deployment) as a service.

Reliability issues and other issues can lead to unpredictable sensor readings in devices. For instance, value drifting, random value, null value, and unpredictable sensor reading values may be received that constitute an anomaly or outlier. However, in IoT systems employing multiple heterogeneous devices and varied combinations of sensors, actuators, and other assets, reliably detecting anomalies that occur in a system, and in particular a customized system (e.g., an IoT system deployed for a specific home or office, etc.) where the combination and use of IoT devices in the deployment may be particularly tailored to a particular floorplan, user preferences, custom IoT application, etc. In such systems, it may be desirable to generate an anomaly detection model that is custom-tailored to a specific deployment or particular devices or sensors within a deployment.

In an addition to the challenges, anomaly detection in IoT systems may be further complicated by the lack of ground truth information. Developing a set of true labels representing the ground truth from which anomalies may be detected can be expensive and impractical. However, the lack of ground truth labels may present a major obstacle preventing machine learning ensemble techniques from being useful in the context of anomaly detection in IoT systems. Additionally, anomalies may manifest in a variety of forms. Indeed, the diversity of potential anomalies appearing in a particular system or a particular device may make it difficult or impossible to fully comprehend the potential array of anomalies using a single machine learning algorithm. For example, in the context of anomaly detection, there may be distance-based, angle-based, distribution-based, and principal component analysis (PCA)-based anomalies, among other examples. Detecting anomalies of diverse characteristics can be a considerable challenge. Further, as anomalies are by their very definition a rarity, most data samples will be negative (i.e., normal or not anomalous) resulting in a general lack of positive (i.e., anomaly) data samples challenging the development of an anomaly detection model. Further, ensemble algorithms in supervised learning has historically struggled to be useful in the context of anomaly detection where essential all data is negative.

Systems, such as those shown and illustrated herein, can include machine logic implemented in hardware and/or software to implement the solutions introduced herein and address at least some of the example issues above (among others). For instance, a system may be provided, which uses a machine learning ensemble that includes multiple unsupervised machine learning algorithms of multiple different types and characteristics to realize improvements over a single machine learning algorithm. These multiple machine learning algorithms may be accessed from a variety of sources, in some implementations, with some algorithms being present and executed locally on the system, while others being executed remotely (at the direction of the system) as a service (e.g., through a corresponding application programming interface (API)). A data set may be provided to be utilized by each of the multiple unsupervised machine learning algorithm and the entropy may be determined for each of the individual algorithms in the ensemble to determine a weighting to be applied to each of the algorithms. A set of pseudo-labels may be generated representing the predictions returned from the machine learning algorithms' processing of the data set and this set of pseudo-labels may then be used as training data for a supervised machine learning algorithm to generate an anomaly detection model corresponding to the device or system from which the data set originates.

As noted above, such example systems may apply an unsupervised ensemble for aggregating a collection of anomaly detection algorithms. Conventional ensemble methods are typically supervised. In one implementation, generalized entropy-based weighting may be applied to an unsupervised ensemble applied in an improved system. Such an unsupervised ensemble requires no labeled data (e.g., or training data that labels some data points as positive or negative), which, as noted above, can be extraordinarily difficult to obtain in the context of anomaly detection. Entropy-based weighted may be similarly determined (or learned by the computing system) without any prior knowledge about the data (i.e., labels) or even the aggregated algorithms, allowing the same to be determined without human intervention. A resulting machine learning-based anomaly detection model may be developed using these unsupervised techniques and the model may then be applied to related real time data to determine predictively whether anomalies are occurring or not. Accordingly, in such example systems, reliable anomaly detection models may be generated without the provision of positive samples or labels, as unsupervised machine learning algorithms are used. Further, while anomalies may be take various forms in various contexts, a diverse ensemble of machine learning algorithms may address the potential diversity of anomalies, which may occur. For instance, in some contexts, positive samples may be far away from the negative samples in metric distance, while in other contexts positive samples may have low correlation with the positive samples, among other examples. Accordingly, no one algorithm can outperform others in arbitrary contexts, however an unsupervised ensemble may enable more generic anomaly detection.

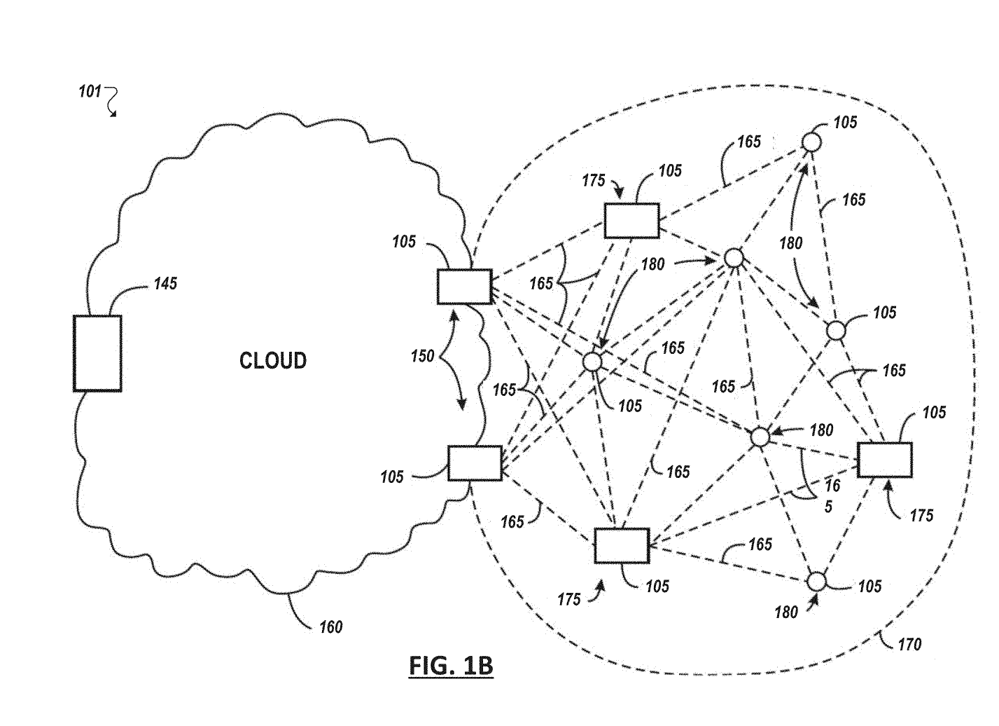

Systems, such as those shown and illustrated herein, can include machine logic implemented in hardware and/or software to implement the systems and solutions introduced herein and address at least some of the example issues above (among others). For instance, FIG. 2 shows a simplified block diagram 200 illustrating a system including multiple IoT devices (e.g., 105b,d) with assets (e.g., sensors (e.g., 110c) and/or actuators (e.g., 115a,b)) capable of being used in a variety of different IoT applications. In the example of FIG. 2, a management system 205 is provided with deployment manager logic 210 (implemented in hardware and/or software) to detect assets within a location and identify opportunities to deploy an IoT system utilizing the detected assets. Deployment can involve automatically identifying and configuring detected assets to participate in a new or ongoing IoT application deployment. During deployment, or runtime operation of an IoT application, anomalies may occur at any one of the devices (e.g., 105b,d) or their composite assets (e.g., 110c, 115a, 115b) deployed in the IoT application. Accordingly, a system 200 may be provided with functionality to effectively detect and trigger resolution of anomalies within an IoT system.

In one example, one or more components within an IoT or WSN system (e.g., a system where multiple devices are working in concert to provide one or more particular services or results) may include functionality for using an anomaly detection model generated by an anomaly management system 215 to detect, in some cases in real time, anomalies occurring in data generated by devices (e.g., 105b,d) within the IoT system. The data in which an anomaly may be detected may be data generated by one or more sensors (e.g., 110c) of the device (as they sense the environment corresponding to the device 105b,d), data describing a state or action performed in connection with one or more actuators of the device (e.g., data describing an “open,” “on,” “close,” or other condition), data generated for a user interface of the device (e.g., 105b,d), data generated by activity logic (e.g., 235, 236) of the device (e.g., 105b,d) (e.g., to process sensor data, actuator state data, or other data locally at the device to realize a further outcome or activity at the device, etc.), among other potential examples.

In the particular example of FIG. 2, a device (e.g., 105b,d) may include one or more data processing apparatus (or “processors”) (e.g., 226, 227), one or more memory elements (e.g., 228, 229), one or more communications modules (e.g., 230, 231), a battery (e.g., 232, 233) or other power source (e.g., a solar cell, etc.), among other components. Each device (e.g., 105b,d) can possess hardware, sensors (e.g., 110c), actuators (e.g., 115a, 115b), and other logic (e.g., 235, 236) to realize the intended function(s) of the device (including operation of the respective sensors and actuators). In some cases, devices may be provided with such assets as one or more sensors (e.g., 110c) of the same or varying types, actuators (e.g., 115a, 115b) of varying types, computing assets (e.g., through a respective processor and/or software logic), security features, data storage assets, and other resources. Communication modules (e.g., 230, 231) may also be utilized as communication assets within some deployments and may include hardware and software to facilitate the device's communication over one or more networks (e.g., 120), utilizing one or more technologies (e.g., WiFi, Bluetooth, Near Field Communications, Zigbee, Ethernet, etc.), with other systems and devices.

In some instances, a device (e.g., 105b,d) may be provided with anomaly detection logic to utilize a locally-stored anomaly detection model (e.g., provided by an anomaly management system 215) to determine when data generated at the device (e.g., 105b,d) constitutes an anomaly. In other instances, anomaly detection may be provided by a gateway device or a management system 205, which has access to data generated by the devices (e.g., 105b,d). In the particular example of FIG. 2, an example management system 205 may include one or more processors (e.g., 212), one or more memory elements (e.g., 214), and one or more communication modules incorporating hardware and logic to allow the management system 205 to communicate over one or more networks (e.g., 120) with other systems and devices (e.g., 105b, 105d, 215, etc.). The deployment manager 210 (and other components) may be implemented utilizing code executable by the processor 212 to manage the automated deployment of a local IoT system. Additional components may also be provided to assist with anomaly detection and reporting in one or more IoT application deployments (including deployments not directly assisted by the management system). For instance, a management system 205 may include anomaly detection and management logic 220, among other example components and features.

As noted above, an anomaly detection logic 220 may be provided to access an anomaly detection model generated by an anomaly management system 215 and detect anomalies in data delivered to the management system from devices (e.g., 105b,d) within an M2M system. The anomaly detection logic 220 may additionally log the reported anomalies and may determine maintenance or reporting events based on the receipt of one or more anomalies. For instance, anomaly detection logic 220 may include functionality for applying a threshold or heuristic to determine an event from multiple anomalies reported by the same or different (nearby or otherwise related) devices (e.g., 105b,d). The anomaly tracker 215 may additionally trigger service tickets, alerts, or other actions based on receiving one or more reported anomalies from the devices (e.g., 105b,d).

In some cases, the management system 205 may be implemented on a dedicated physical system (e.g., separate from other devices in the IoT deployment). For instance, the management system 205 may be implemented on a gateway device used to facilitate communication with and between multiple potential IoT devices (e.g., 105b,d) within a particular location. In some instances, the management system 205 may be hosted at least in part on a user device (e.g., a personal computer or smartphone), including a user device that may itself be utilized in the deployment of a particular IoT application. Indeed, the management system 205 (and deployment manager 210) may be implemented on multiple devices, with some functionality of the management system 205 hosted on one device and other functionality hosted on other devices. A management system 205 may, in some cases, be hosted partially or entirely remote from the environment in which the IoT or WSN devices (e.g., 105b,d) are to be deployed. Indeed, a management system 205 may be implemented using one or more remote computing systems, such as cloud-based resources, that are remote from the devices, gateways, etc. utilized in a given IoT application or WSN deployment.

An anomaly management system 215 may be provided to utilize unsupervised machine learning algorithms to process data generated by devices (e.g., 105b,d) in an IoT deployment and develop an anomaly detection model applicable to detecting anomalies on one or more of the devices (e.g., 105b,d). An example anomaly management system 215 may include one or more data processing apparatus (e.g., 238), one or more memory elements (e.g., 240) with code (implemented in hardware, firmware, and/or software) executable by the processor to implement an ensemble manager (e.g., 245), weighting engine (e.g., 250), label generator (e.g., 255), and model generator (e.g., 260), among other examples and combinations of the foregoing. In one example, an ensemble manager 245 may be provided, which may be operable to allow a collection of two or more unsupervised machine learning algorithms to be selected to predict anomaly events for a particular sensor, sensor model, sensor type, or grouping of the same or different sensors (e.g., on a single device or within a particular system, etc.). In some implementations, a user may select a collection of different diversified unsupervised machine learning algorithms for use in generating an anomaly detection model for a particular set of sensors. In some cases, the ensemble manager 245 may self-identify one or more of the unsupervised machine learning algorithms 270, for instance, by identifying one or more of the sensors in the set for which the ensemble is to be created. For instance, the ensemble manager 245 may identify that a particular one of the sensors is of a particular type or model and identify, for instance, from a library or other collection of available machine learning algorithms 270, which of the algorithms would be relevant for detecting anomalies in data generated by the particular sensor. The ensemble manager 240, in some cases, may reuse the overlapping sets of unsupervised machine learning algorithms in the development of different ensembles for use in generating anomaly detection models for different sensors or groups of sensors, among other examples.

Some of the unsupervised machine learning algorithms selected for inclusion in a particular ensemble may include machine learning algorithms embodied in code stored and executed locally at the anomaly management system 215. Unsupervised machine learning algorithms included in an ensemble may additionally or alternatively be hosted by remote computing systems (not shown) and these algorithms may be executed on behalf of the anomaly management system 215, for instance, in response to a request or transaction initiated by the anomaly management system 215 via an API, with the performance of the algorithm be provided as a service to the anomaly management system. In some implementations, a blend of unsupervised and supervised machine learning algorithms may be selected for use together in the ensemble. In such cases, the supervised machine learning algorithms may be trained by a previous (and, in some cases, no longer current) set of data related to the sensors, among other examples.

Regardless of the implementation and the mix of locally and remotely executed unsupervised machine learning algorithms, sensor data 265 generated by one or more sensors (e.g., 110c) or other assets may be accessed by the anomaly management system 215 to generate a corresponding anomaly detection model (e.g., 280). An anomaly management system 215 may receive the sensor data 265 directly from one or more instances of a device (e.g., 105b,d) implementing the one or more sensors (e.g., 110c) or may receive the sensor data 265 from another aggregator of sensor data (e.g., management system 205, an IoT gateway, the device (e.g., 105b,d) itself, etc.

The sensor data 265 may be provided and pre-processed to make the data ready for consumption by the selected ensemble of unsupervised machine learning algorithms. The unsupervised machine learning algorithms may each independently use (e.g., in parallel) the sensor data 265 to make various anomaly predictions for each data point or subset of data points in the sensor data 265 (e.g., as defined for the domain (e.g., set of sensors) for which the anomaly detection model is to be developed). A weighting engine 250 may utilize the results of each of the machine learning algorithms' performances using the sensor data 265 to determine an entropy value for each performance of the algorithms. The entropy value may then be utilized by the weighting engine 250 to autonomously determine a weighting for each of the machine learning algorithms' results. These weightings may then be applied to each of the predictions, or votes, of each respective algorithm to determine an aggregate, ensemble prediction for each data point or collection of data points. This ensemble prediction may be designated as a pseudo label (representing an ersatz ground truth) corresponding to that particular data point. Accordingly, running the ensemble of machine learning algorithms may be used to generate (e.g., using a label generator 255) a set of pseudo labels 275 for the sensor data. This set of pseudo labels may be used as a training data set for a supervised machine learning algorithm (e.g., selected for use by a model generator 260) to determine a corresponding supervised machine learning anomaly detection model based on the labels 275. This resulting anomaly detection model (e.g., 280) may then be provided to anomaly detection logic (e.g., 220) on a management system (e.g., 205), IoT gateway, a device (e.g., 105b,d), etc. to detect anomalies occurring in subsequently generated sensor data generated by the corresponding sensors or groups of sensors, in the same or a different (but similar) deployment of the sensors, among other examples.

As noted above, an IoT deployment and application may involve one or more backend services, such as provided by one or more application servers (e.g., 145). In one example, an application server 145 may include one or more data processing apparatus 282, one or more memory elements 284, and one or more communication modules 286 incorporating hardware and logic to allow the application server 145 to communicate over one or more networks (e.g., 120) (e.g., with a management system 205, IoT gateway, directly with an IoT device (e.g., 105b,d), etc.). The application server 145 may further run an operating system 288 and one or more applications 290. The applications 290 may consume and/or generate various data 295 hosted at the application server 145 (or other data stores). Applications 290 may, in some cases, include service logic utilized during runtime and/or deployment of an IoT system (e.g., including devices 105b,d) or may be services, which are consumed by elements of the service logic utilized in an IoT system deployment (e.g., and hosted on devices (e.g., 105b,d), management system 205, user device 130, or other machines associated with an IoT system's deployment. An application (e.g., 290) in one example may receive data generated by one or more sensor assets (e.g., 110c) of one or more devices (e.g., 105b,d) deployed in an IoT system and apply logic embodied in one or more application 270 to generate results, which may be presented in a report or graphical user interface (GUI) of a user device (e.g., 130). Such results may even be returned to one or more of the participating devices (e.g., 105b,d) for consumption by the deployed device (e.g., in connection with the triggering of an actuator asset (e.g., 115a) of the device (e.g., 105b)) during runtime of the IoT system, among other, potentially limitless examples.

User devices (e.g., 130) may be utilized in a variety of ways within an IoT application deployment. User devices may possess management system functionality, functionality of an IoT service development system, may be utilized to control or manage a particular IoT application (e.g., through a UI of the IoT application provided on the device 130), or to provide other assets (e.g., sensor, actuator, computing, or storage) for use in a particular IoT application deployment. In one example, a user device 130 may include a UI engine, which may be leveraged in a particular IoT application deployment to provide one or more UIs for use by a user in connection with the deployment. A user device 130 may include one or more data processors, one or more memory elements, a communication module enabling communication with other systems using wireless and/or wireline network connections, and an operating system on which one or more applications may be run. A user device 130 may include one or more input devices, which may embody sensors implementing a touchscreen interface, keyboard, tracker ball, camera, or other mechanism through which user inputs may be captured. A user device 130 may also include one or more presentation devices (e.g., driven by corresponding actuators) to implement a graphical display, an audio presentation (e.g., speakers), a light output (e.g., of an integrated LED flashlight or camera flash), or vibration motor to output vibration-based signals, among other examples. Input devices and presentation devices, and computing resources of a user device (e.g., 130) may be utilized to fulfill UI requirements of a particular IoT application, resulting in the deployment of a user device (e.g., 130) in connection with deployment of the particular IoT application, among other example uses.

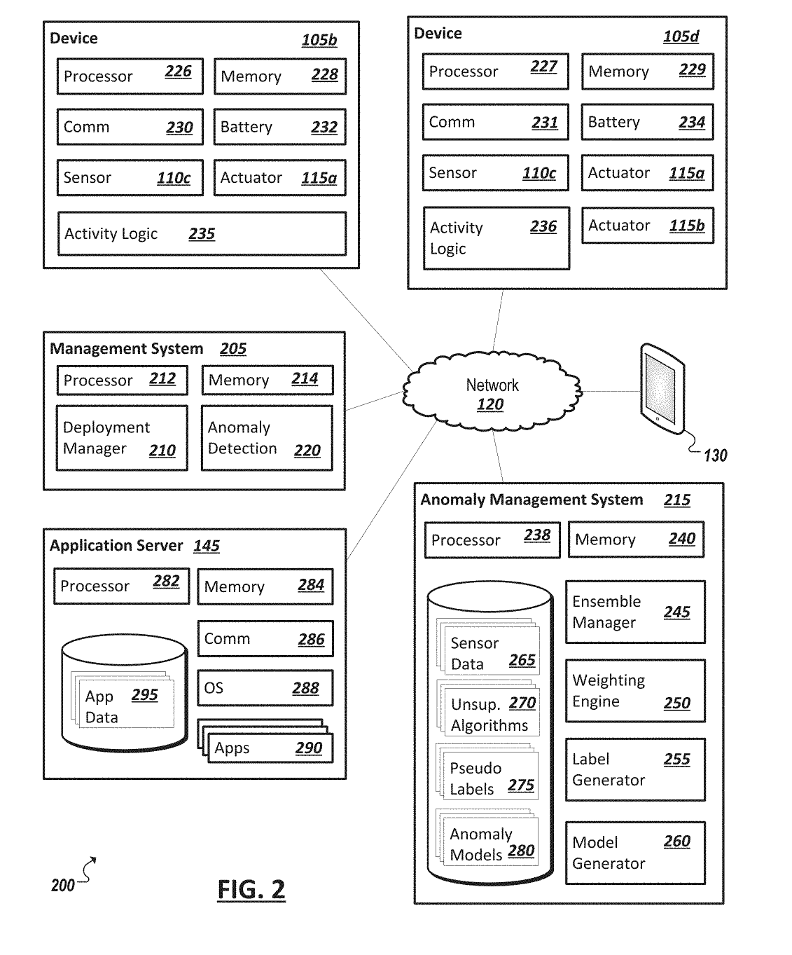

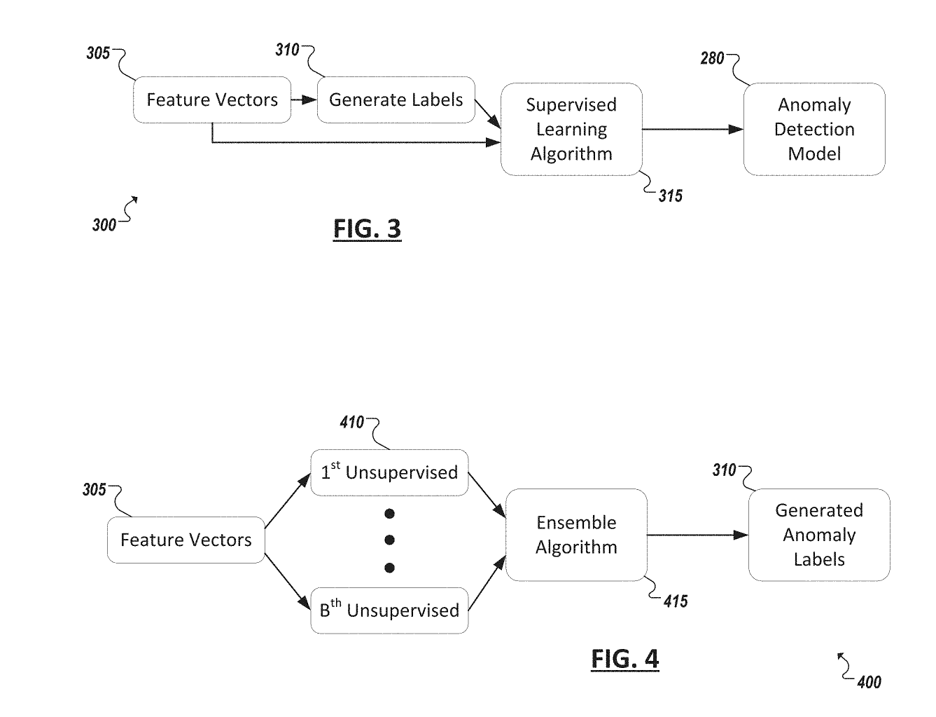

Turning to the simplified flow diagram 300 of FIG. 3, a representation is shown of the example generation of an anomaly detection model from sensor data generated by a set of sensors. The set of sensors may be multiple sensors of the same type but on different devices, multiple sensors of the same type on the same device, multiple sensors of different types on the same device, multiple sensors of different types on two or more distinct devices deployed in the same system (e.g., a localized IoT system), among other examples. The sensor data may include multiple data points from the sensors collected over a period of time (e.g., multiple data generation intervals). Accordingly, vectors (e.g., feature vectors) 305 may be developed from a collection of contemporaneous data points from the same or different sensors at particular point or division of time. The feature vectors 305 may be utilized to generate pseudo labels 310, from which a supervised leaning algorithm may be used to determine an anomaly detection model. As shown in the simplified flow diagram 400 of FIG. 4, generation of the pseudo labels (e.g., 310) may include feeding the feature vectors as input data for an ensemble of multiple unsupervised machine learning algorithms (at 410), from which an ensemble algorithm 415 may take the various respective results generated by multiple machine learning algorithms 410 to determine, for each data point or vector, a respective prediction based on the combined predictions of the multiple machine learning algorithms 410 for that vector. This may include determining a weighting for each of these predictions (e.g., based on a determined entropy for each algorithm). This ensemble algorithm 415 may be utilized to generate the pseudo-labels 420 to be used by the supervised machine leaning algorithm 315 to generate a corresponding anomaly detection model 280.

As noted above, an anomaly detection model may be developed for a particular domain through an ensemble of arbitrary unsupervised algorithms, without learning ground truth, with optimal weighting for the ensemble and its results being determined, autonomously, based on entropy determined from the running of the ensemble of algorithms. For instance, given a set of feature vectors D={xₙ|xₙεR^{d}}ₙ₌₁^{N}, where each xᵢ represents values from multiple sensors, R is a real number, d is the length of the feature vector (e.g., corresponding to a number of features represented by the feature vector), and a set of unsupervised anomaly detection algorithms A₁, . . . , A_{B}, where each Aⱼ outputs a respective set of anomaly predictions zⱼ, given D as Aⱼ(D)→zⱼε{+1, −1}^{N}. From this formulation, a set of ensemble anomaly predictions yε{+1, −1}^{N} from z_{B}, may be produced from the algorithms and a supervised learning algorithm L may be exploited to learn on the resulting set {(xₙ, y[n])}ₙ₌₁^{N} generated from the ensemble's predictions to obtain a new anomaly detection model g.

As noted above, anomaly detection is challenging as definitive labels, especially positive labels, are costly to obtain with respect to the data set of interest. While some unsupervised algorithms have been put forward to address this challenge, predictions made by unsupervised anomaly algorithms require access to data in batch, making online and real-time predictions intractable. Further, as in some of the examples herein, a set of pseudo labels of anomaly for a data set of interest may be generated and then used by a supervised learning algorithms to learn an anomaly prediction model. As noted in FIG. 3, by employing label generation 310, the original (unsupervised) anomaly detection problem can be transformed to a classic supervised learning problem whose goal is to learn from feature vectors and the (generated) labels. Supervised learning algorithms can then be applied accordingly to learn an anomaly detection model 280 capable of being then used to realize online, real-time anomaly prediction.

Another issue facing the learning of an anomaly detection model supervisedly is the sparsity of positive labels, or namely, the imbalance of the target data set. In the scenario of anomaly detection, an instance is far more frequently associated with normality than with anomaly. A good label generation algorithm, which should reflect such an underlying nature of anomaly detection problem, also presents the same issue to the traditional supervised learning algorithms. The learning of such imbalanced data may be handled by assigning user-specified weight to instances associated c with anomaly, where c controls the balance between false alarm and the miss detection of anomaly.

As noted above, pseudo anomaly labels may be generated (e.g., as outlined in FIG. 4) by an ensemble of different unsupervised learning algorithms, for use as training data in a supervised anomaly detection algorithm. By incorporating different combinations of unsupervised algorithms and parameters, ensemble approach can effectively handle the diversity of anomalies without further tuning of parameters. An ensemble approach may effectively handle the diversity of anomalies. In some cases, ensemble decisions of generated anomaly labels may be determined by equally-weighted voting of different unsupervised algorithms. However, in some instances, given the diversity of unsupervised algorithms selected for an example ensemble, reliabilities of different unsupervised algorithms may vary when data of different characteristics are considered. Accordingly, in some implementations, the different respective (appropriate) weights of unsupervised algorithms may be determined dynamically to reflect the potential diversity of their results. For instance, an ensemble algorithm (e.g., 415) may be utilized that learns the weights of unsupervised algorithms by minimizing the uncertainty of generated anomaly labels measured by entropy. Specifically, by exploiting B unsupervised algorithms on D to get z₁, . . . , z_{B}, a label set {v}ₙ₌₁^{N} may be obtained, where vₙ[j]=zⱼ[n], with an optimal weighting w* being determined according to:

$${w}^{*} = {argmin}_{w} {\sum }_{n = 1}^{N} - σ ( {v}_{n}^{T} {w}^{*} ) log ( σ ( {v}_{n}^{T} {w}^{*} ) ) - ( 1 - σ ( {v}_{n}^{T} {w}^{*} ) ) log ( 1 - σ ( {v}_{n}^{T} {w}^{*} ) )$$

where σ(s)=(1+exp(−s))⁻¹. However, as the above optimization problem may be non-convex, stochastic gradient descent (SGD) may be utilized, if a mini-bath of label set {v_{q}}_{q=1}^{Q} is considered, to update w as follows:

$$w ← w - γ {\sum }_{q = 1}^{Q} σ ( {β}_{q} ) σ ( - {β}_{q} ) {β}_{q}$$

where β_{q}=v_{q}^{T}w. γ is a parameter that controls the learning rate of the SGD algorithm. The final generated anomaly label decisions y may then be determined, for instance, according to y[n]=sign(vₙ^{T}w*). An anomaly detection model can be learned accordingly on {(xₙ, y[n])}ₙ₌₁^{N} as described previously. Accordingly, an anomaly detection model generator may autonomously develop not only a set of pseudo labels from an ensemble of unsupervised machine learning algorithms, including the derivation of weights, or the relative importance, of the different unsupervised algorithms in an unsupervised manner.

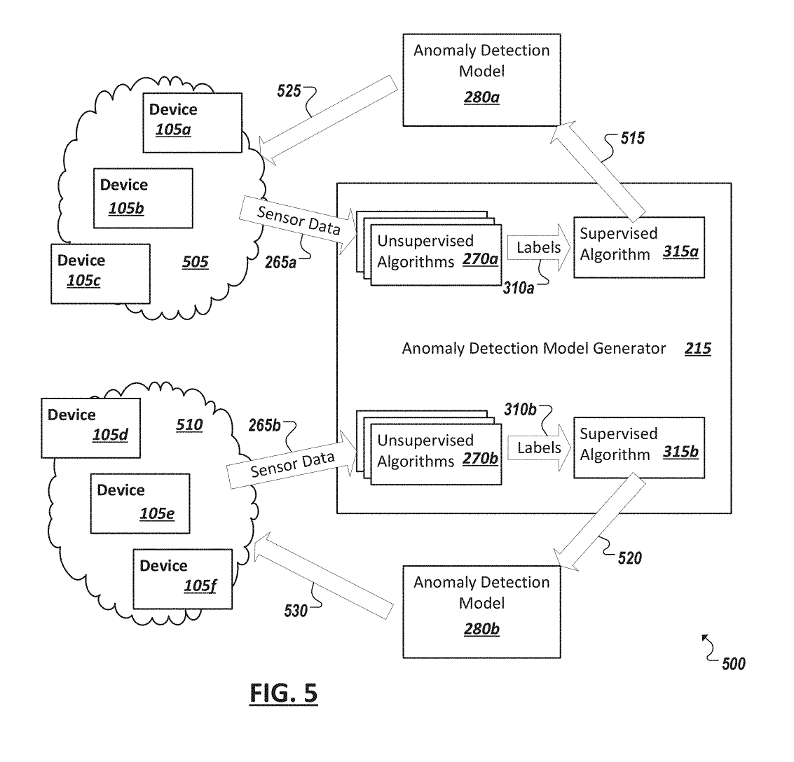

Turning to the example of FIG. 5, a simplified block diagram 500 is shown illustrating use of an example anomaly detection model generator 215. An anomaly detection model generator 215 may be provided to generate multiple different anomaly detection models (e.g., 280a,b) for multiple different domains. For instance, a domain may relate to a collection of the same or different sensors on one or more devices (e.g., 105a-f) in a particular deployment or potentially multiple different deployments. A domain may be defined in order to determine anomalies with respect to that particular domain. For instance, a domain, in one instance, may pertain to multiple different sensors (e.g., thermal, humidity, and vibration sensors) on a single device and determining anomalies that may appear in the combined readings (e.g., temperature, humidity, and vibration readings) generated at each point in time (e.g., the time in which a reading is generated and/or sent) by the device (e.g., 105a). In another example, a domain may be defined for a grouping of devices (e.g., 105d-f), which all may at least have an instance of a particular sensor. The grouping of devices may be positioned within a physical environment and a domain may be defined in which anomalies in the combined sensor data generated by each of these distinct instances of a particular sensor (e.g., a light sensor, temperature, or some other sensor type). For instance, a corresponding vector may be derived from the sensor data of such a domain from three readings generated at a particular time by the three respective sensors on the three respective devices (e.g., 105d-f), among a variety of other potential domain examples.

Regardless of the domain for which an anomaly detection model (e.g., 280a-b) is to be generated, sensor data 265a may be obtained corresponding to a first domain (e.g., corresponding to one or more sensors in a set of one or more device deployed in a first deployments 505). A set of varied unsupervised machine learning algorithms 270a may be selected that is appropriate for predicting anomalies for this first domain using the corresponding sensor data 265a (and feature vectors derivable from the sensor data 265a). Corresponding pseudo labels 310a may be generated based on the ensemble of unsupervised algorithms 270a and an ensemble algorithm (e.g., deriving weighting for the unsupervised algorithms' predictions). An appropriate supervised machine learning algorithm 315a (or even an ensemble of supervised machine learning algorithms) applicable to anomaly detection for the first domain may be selected and use the developed labels 310a to determine 515 an anomaly detection model 280a for the domain. This anomaly detection model 280a may then be provided 525 for use by a management system, device, or other system to detect anomalies appearing in subsequently-generated data for the first domain.

An anomaly detection model generator 215 may flexibly also generate anomaly detection models (e.g., 280b) for other unrelated domains. For instance, different sensor data 265b may be retrieved or otherwise received that corresponds to a different, second domain. Indeed, multiple different domains may be defined even within the same device, IoT deployment or system. An ensemble of unsupervised machine learning anomaly detection algorithms 270b may likewise be selected that represent varied algorithms capable of predicting anomalies for this second domain. The ensemble 270b selected for the second domain may be the same or different from the ensemble 270a selected for the first domain (e.g., different in that ensemble 270b includes at least one algorithm not included in the ensemble 270a or omits at least one algorithm included in the ensemble 270a, etc.). Feature vectors may be derived from the sensor data 265b and processed by the selected ensemble 270b of unsupervised algorithms and an ensemble weighting algorithm (e.g., based on entropy) to determine a corresponding set of pseudo labels 310b for the second domain. The same or a different supervised machine learning anomaly detection algorithm 315b may be selected and use the pseudo labels 310b as a training set to determine 520 the anomaly detection model 280b for the second domain. This second anomaly detection model 280b may be likewise provided 530 to a system associated with the second domain, which possess computing logic capable of using the anomaly detection model 280b to detect anomalies in subsequent sensor data of the second domain, among other examples.

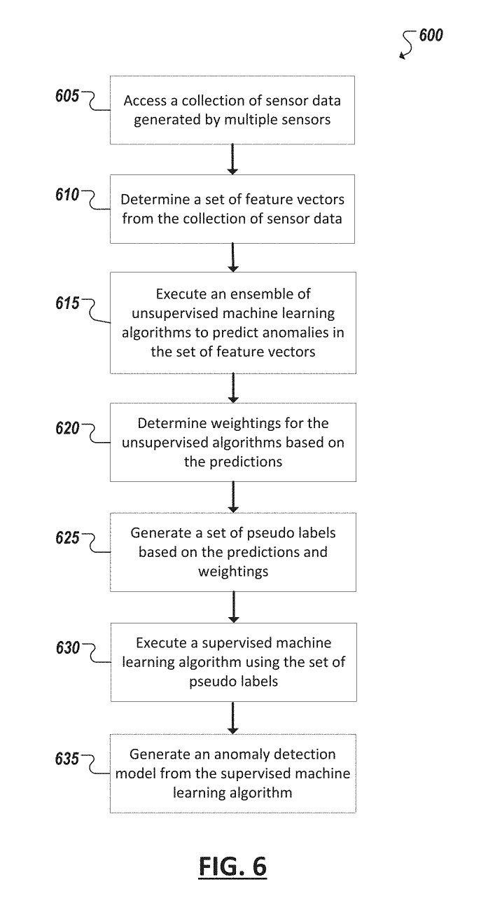

Turning to the simplified flow diagram 600 of FIG. 6, an example technique for generating an anomaly detection model using an ensemble of unsupervised machine learning algorithms is illustrated. For instance, a collection of sensor data generated by multiple sensors may be accessed 605. For instance, the sensor data may be passed (e.g., as it is generated) to an anomaly detection model generator. A set of feature vectors may be determined 610 from the sensor data and used in the execution 615 of an ensemble of unsupervised anomaly detection machine learning algorithms. Executing the ensemble of the unsupervised anomaly detection machine learning algorithms produces a collection of predictions for each of the set of feature vectors. These predictions may be used to determine 620 weightings (e.g., entropy-based weightings) for each of the unsupervised anomaly detection machine learning algorithms, which may be used, together with the predictions to generate pseudo labels from the predictions. These pseudo labels, unlike supervised labels, may represent a predicted ground truth and may stand in in the absence of actual supervised labels. A supervised machine learning algorithm may be provided with the set of pseudo labels as training data, and the supervised machine learning algorithm may be executed 630 to determine and generate 635 an anomaly detection model that may be used to detect anomalies in subsequent sensor data generated by the multiple sensors (or even other sensors similar to the multiple sensors (e.g., another deployment of a similar grouping of sensors)), among other examples.

While some of the systems and solution described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

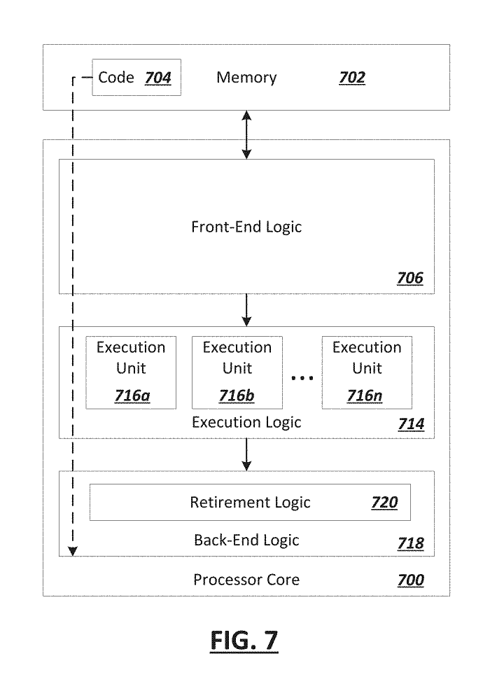

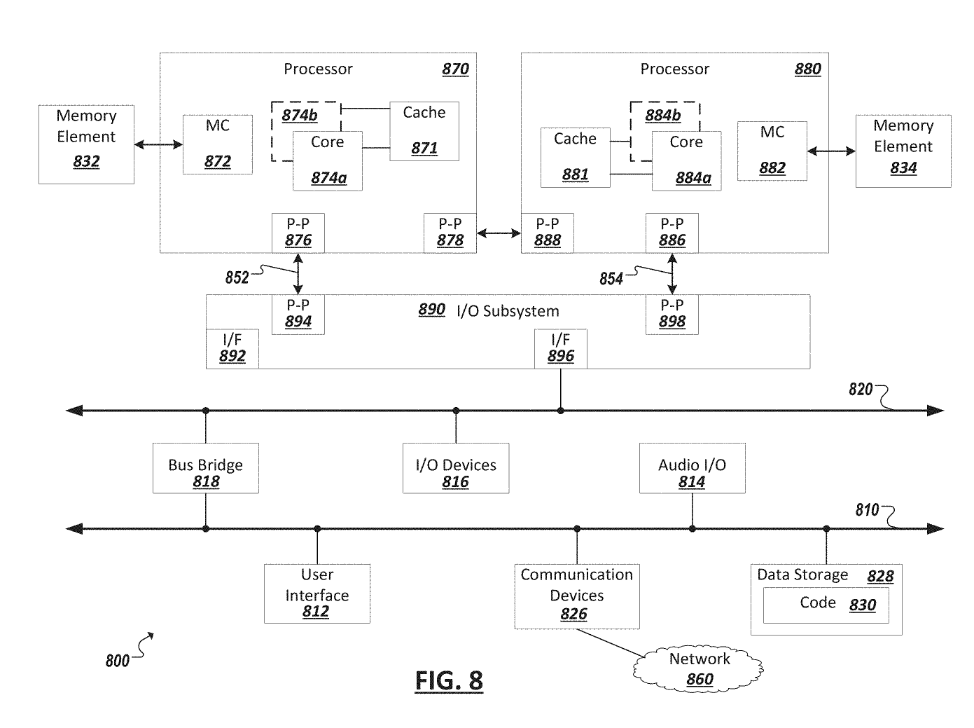

FIGS. 7-8 are block diagrams of exemplary computer architectures that may be used in accordance with embodiments disclosed herein. Other computer architecture designs known in the art for processors and computing systems may also be used. Generally, suitable computer architectures for embodiments disclosed herein can include, but are not limited to, configurations illustrated in FIGS. 7-8.

FIG. 7 is an example illustration of a processor according to an embodiment. Processor 700 is an example of a type of hardware device that can be used in connection with the implementations above. Processor 700 may be any type of processor, such as a microprocessor, an embedded processor, a digital signal processor (DSP), a network processor, a multi-core processor, a single core processor, or other device to execute code. Although only one processor 700 is illustrated in FIG. 7, a processing element may alternatively include more than one of processor 700 illustrated in FIG. 7. Processor 700 may be a single-threaded core or, for at least one embodiment, the processor 700 may be multi-threaded in that it may include more than one hardware thread context (or “logical processor”) per core.

FIG. 7 also illustrates a memory 702 coupled to processor 700 in accordance with an embodiment. Memory 702 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 700 can execute any type of instructions associated with algorithms, processes, or operations detailed herein. Generally, processor 700 can transform an element or an article (e.g., data) from one state or thing to another state or thing.

Code 704, which may be one or more instructions to be executed by processor 700, may be stored in memory 702, or may be stored in software, hardware, firmware, or any suitable combination thereof, or in any other internal or external component, device, element, or object where appropriate and based on particular needs. In one example, processor 700 can follow a program sequence of instructions indicated by code 704. Each instruction enters a front-end logic 706 and is processed by one or more decoders 708. The decoder may generate, as its output, a micro operation such as a fixed width micro operation in a predefined format, or may generate other instructions, microinstructions, or control signals that reflect the original code instruction. Front-end logic 706 also includes register renaming logic 710 and scheduling logic 712, which generally allocate resources and queue the operation corresponding to the instruction for execution.

Processor 700 can also include execution logic 714 having a set of execution units 716a, 716b, 716n, etc. Some embodiments may include a number of execution units dedicated to specific functions or sets of functions. Other embodiments may include only one execution unit or one execution unit that can perform a particular function. Execution logic 714 performs the operations specified by code instructions.

After completion of execution of the operations specified by the code instructions, back-end logic 718 can retire the instructions of code 704. In one embodiment, processor 700 allows out of order execution but requires in order retirement of instructions. Retirement logic 720 may take a variety of known forms (e.g., re-order buffers or the like). In this manner, processor 700 is transformed during execution of code 704, at least in terms of the output generated by the decoder, hardware registers and tables utilized by register renaming logic 710, and any registers (not shown) modified by execution logic 714.

Although not shown in FIG. 7, a processing element may include other elements on a chip with processor 700. For example, a processing element may include memory control logic along with processor 700. The processing element may include I/O control logic and/or may include I/O control logic integrated with memory control logic. The processing element may also include one or more caches. In some embodiments, non-volatile memory (such as flash memory or fuses) may also be included on the chip with processor 700.

FIG. 8 illustrates a computing system 800 that is arranged in a point-to-point (PtP) configuration according to an embodiment. In particular, FIG. 8 shows a system where processors, memory, and input/output devices are interconnected by a number of point-to-point interfaces. Generally, one or more of the computing systems described herein may be configured in the same or similar manner as computing system 800.

Processors 870 and 880 may also each include integrated memory controller logic (MC) 872 and 882 to communicate with memory elements 832 and 834. In alternative embodiments, memory controller logic 872 and 882 may be discrete logic separate from processors 870 and 880. Memory elements 832 and/or 834 may store various data to be used by processors 870 and 880 in achieving operations and functionality outlined herein.

Processors 870 and 880 may be any type of processor, such as those discussed in connection with other figures. Processors 870 and 880 may exchange data via a point-to-point (PtP) interface 850 using point-to-point interface circuits 878 and 888, respectively. Processors 870 and 880 may each exchange data with a chipset 890 via individual point-to-point interfaces 852 and 854 using point-to-point interface circuits 876, 886, 894, and 898. Chipset 890 may also exchange data with a high-performance graphics circuit 838 via a high-performance graphics interface 839, using an interface circuit 892, which could be a PtP interface circuit. In alternative embodiments, any or all of the PtP links illustrated in FIG. 8 could be implemented as a multi-drop bus rather than a PtP link.

Chipset 890 may be in communication with a bus 820 via an interface circuit 896. Bus 820 may have one or more devices that communicate over it, such as a bus bridge 818 and I/O devices 816. Via a bus 810, bus bridge 818 may be in communication with other devices such as a user interface 812 (such as a keyboard, mouse, touchscreen, or other input devices), communication devices 826 (such as modems, network interface devices, or other types of communication devices that may communicate through a computer network 860), audio I/O devices 814, and/or a data storage device 828. Data storage device 828 may store code 830, which may be executed by processors 870 and/or 880. In alternative embodiments, any portions of the bus architectures could be implemented with one or more PtP links.

The computer system depicted in FIG. 8 is a schematic illustration of an embodiment of a computing system that may be utilized to implement various embodiments discussed herein. It will be appreciated that various components of the system depicted in FIG. 8 may be combined in a system-on-a-chip (SoC) architecture or in any other suitable configuration capable of achieving the functionality and features of examples and implementations provided herein.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

In general, one aspect of the subject matter described in this specification can be embodied in methods and executed instructions that include or cause the actions of identifying a sample that includes software code, generating a control flow graph for each of a plurality of functions included in the sample, and identifying, in each of the functions, features corresponding to instances of a set of control flow fragment types. The identified features can be used to generate a feature set for the sample from the identified features

These and other embodiments can each optionally include one or more of the following features. The features identified for each of the functions can be combined to generate a consolidated string for the sample and the feature set can be generated from the consolidated string. A string can be generated for each of the functions, each string describing the respective features identified for the function. Combining the features can include identifying a call in a particular one of the plurality of functions to another one of the plurality of functions and replacing a portion of the string of the particular function referencing the other function with contents of the string of the other function. Identifying the features can include abstracting each of the strings of the functions such that only features of the set of control flow fragment types are described in the strings. The set of control flow fragment types can include memory accesses by the function and function calls by the function. Identifying the features can include identifying instances of memory accesses by each of the functions and identifying instances of function calls by each of the functions. The feature set can identify each of the features identified for each of the functions. The feature set can be an n-graph.

Further, these and other embodiments can each optionally include one or more of the following features. The feature set can be provided for use in classifying the sample. For instance, classifying the sample can include clustering the sample with other samples based on corresponding features of the samples. Classifying the sample can further include determining a set of features relevant to a cluster of samples. Classifying the sample can also include determining whether to classify the sample as malware and/or determining whether the sample is likely one of one or more families of malware. Identifying the features can include abstracting each of the control flow graphs such that only features of the set of control flow fragment types are described in the control flow graphs. A plurality of samples can be received, including the sample. In some cases, the plurality of samples can be received from a plurality of sources. The feature set can identify a subset of features identified in the control flow graphs of the functions of the sample. The subset of features can correspond to memory accesses and function calls in the sample code.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The following examples pertain to embodiments in accordance with this Specification. One or more embodiments may provide a method, a system, apparatus, and a machine readable storage medium with stored instructions executable to identify a collection of data generated by a plurality of sensors, generate a set of feature vectors from the collection of data, execute a plurality of unsupervised anomaly detection machine learning algorithms in an ensemble using the set of feature vectors, generate a set of pseudo labels based on predictions made during execution of the plurality of unsupervised anomaly detection machine learning algorithms using the set of feature vectors, and execute a supervised machine learning algorithm using the set of pseudo labels as training data to determine an anomaly detection model corresponding to the plurality of sensors.

In one example, a respective weighting for each of the plurality of unsupervised anomaly detection machine learning algorithms is determined.

In one example, each of the weightings includes a respective entropy-based weighting based on determinations made by the plurality of unsupervised anomaly detection machine learning algorithms during execution of the plurality of unsupervised anomaly detection machine learning algorithms.

In one example, stochastic gradient descent (SGD) is used to determine the entropy-based weightings.

In one example, the set of pseudo labels is generated based on the weightings.

In one example, the set of pseudo labels represent a ground truth.

In one example, the plurality of unsupervised anomaly detection machine learning algorithms includes a plurality of different plurality of unsupervised anomaly detection machine learning algorithms.

In one example, a first one of the plurality of different unsupervised anomaly detection machine learning algorithms detects anomalies based on a first characteristic and a second one of the plurality of different unsupervised anomaly detection machine learning algorithms detects anomalies based on a second characteristic.

In one example, the first unsupervised anomaly detection machine learning algorithm detects one distance-based, angle-based, distribution-based, and principal component analysis (PCA)-based anomalies.

In one example, the anomaly detection model is to be used to determine whether a subsequent collection of sensor data includes one or more anomalies.

In one example, the anomaly detection model is sent to a remote to determine at the remote system whether the subsequent collection of sensor data includes one or more anomalies.

In one example, the subsequent collection of sensor data is accessed and the anomaly detection model is used to determine whether the subsequent collection of sensor data includes one or more anomalies.

In one example, another collection of data is identified generated by a different plurality of sensors, another set of feature vectors is generated from the other collection of data, another plurality of unsupervised anomaly detection machine learning algorithms in another ensemble is executed using the other set of feature vectors to generate another set of pseudo labels (e.g., based on weightings determined for this other plurality of unsupervised algorithms), and another supervised machine learning algorithm is executed using the other set of pseudo labels as training data, to determine another anomaly detection model corresponding to the other plurality of sensors.

In one example, the plurality of unsupervised anomaly detection machine learning algorithms are selected from a collection of unsupervised anomaly detection machine learning algorithms, where the plurality of unsupervised anomaly detection machine learning algorithms include a subset of the collection of unsupervised anomaly detection machine learning algorithms.

In one example, the plurality of unsupervised anomaly detection machine learning algorithms is selected based on a user input provided through a user interface of a host computer.

One or more embodiments may provide a system including a data processor device, computer memory, and an anomaly detection model generator, executable by the data processor device to receive sensor data generated by a plurality of sensors, determine a plurality of feature vectors from the sensor data, execute a plurality of unsupervised anomaly detection machine learning algorithms in an ensemble using the plurality of feature vectors to generate a set of predictions, determine, from the set of predictions, respective entropy-based weightings for each of the plurality of unsupervised anomaly detection machine learning algorithms, generate a set of pseudo labels based on the predictions and weightings, and execute a supervised machine learning algorithm using the set of pseudo labels as training data, to generate an anomaly detection model corresponding to the plurality of sensors.

In one example, the system further includes the plurality of sensors.

In one example, the anomaly detection model generator is further to provide the anomaly detection model to one or more of the plurality of sensors, where the one or more of the sensors are to process subsequent sensor data using the anomaly detection model to determine whether the subsequent sensor data includes one or more anomalies.

In one example, the system further includes one or more devices hosting the plurality of sensors.

In one example, the plurality of sensors are hosted on a single device.

In one example, the plurality of sensors are hosted on a plurality of devices.

In one example, the plurality of devices include a deployment of an Internet of Things (IoT) system.

In one example, the Internet of Things (IoT) system includes a localized deployment within a particular location.

In one example, the plurality of sensors include a plurality of different types of sensors.

In one example, the system further includes a gateway device through which the plurality of sensors communicates on a network, where the anomaly detection model generator is further to provide the anomaly detection model to the gateway device, and the gateway device is to process subsequent sensor data received from the plurality of sensors using the anomaly detection model to determine whether the subsequent sensor data includes one or more anomalies.

In one example, the system further includes a management system to trigger a remedy in response to detection of an anomaly in subsequent sensor data generated by the plurality of sensors using the anomaly detection model.

In one example, the remedy includes reconfiguring a system including the plurality of sensor to replace one of the sensors within another sensor.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. At least one machine accessible storage medium having instructions stored thereon, the instructions when executed on a machine, cause the machine to:
identify a collection of data, wherein the collection of data comprises data generated by a plurality of sensors;
generate a set of feature vectors from the collection of data;
execute a plurality of unsupervised anomaly detection machine learning algorithms in an ensemble using the set of feature vectors;
generate a set of pseudo labels based on predictions made during execution of the plurality of unsupervised anomaly detection machine learning algorithms using the set of feature vectors; and
execute a supervised machine learning algorithm using the set of pseudo labels as training data to determine an anomaly detection model corresponding to the plurality of sensors.

2. The storage medium of claim 1, wherein the instructions, when executed, further cause a machine to determine a respective weighting for each of the plurality of unsupervised anomaly detection machine learning algorithms.

3. The storage medium of claim 2, wherein each of the weightings comprises a respective entropy-based weighting based on determinations made by the plurality of unsupervised anomaly detection machine learning algorithms during execution of the plurality of unsupervised anomaly detection machine learning algorithms.

4. The storage medium of claim 3, wherein stochastic gradient descent (SGD) is used to determine the entropy-based weightings.

5. The storage medium of claim 2, wherein the set of pseudo labels is generated based on the weightings.

6. The storage medium of claim 1, wherein the set of pseudo labels represent a ground truth.

7. The storage medium of claim 1, wherein the plurality of unsupervised anomaly detection machine learning algorithms comprise a plurality of different plurality of unsupervised anomaly detection machine learning algorithms.

8. The storage medium of claim 7, wherein a first one of the plurality of different unsupervised anomaly detection machine learning algorithms detects anomalies based on a first characteristic and a second one of the plurality of different unsupervised anomaly detection machine learning algorithms detects anomalies based on a second characteristic.

9. The storage medium of claim 8, wherein the first unsupervised anomaly detection machine learning algorithm detects one distance-based, angle-based, distribution-based, and principal component analysis (PCA)-based anomalies.

10. The storage medium of claim 1, wherein the anomaly detection model is to be used to determine whether a subsequent collection of sensor data comprises one or more anomalies.

11. The storage medium of claim 10, wherein the instructions, when executed, further cause the machine to send the anomaly detection model to a remote to determine at the remote system whether the subsequent collection of sensor data comprises one or more anomalies.

12. The storage medium of claim 10, wherein the instructions, when executed, further cause the machine to:
access the subsequent collection of sensor data; and
determine, using the anomaly detection model, whether the subsequent collection of sensor data comprises one or more anomalies.

13. The storage medium of claim 1, wherein the instructions, when executed, further cause the machine to:
identify another collection of data, wherein the other collection of data comprises data generated by a different plurality of sensors;
generate another set of feature vectors from the other collection of data;
execute another plurality of unsupervised anomaly detection machine learning algorithms in an ensemble using the other set of feature vectors to generate another set of pseudo labels; and
execute another supervised machine learning algorithm using the other set of pseudo labels as training data, to determine another anomaly detection model corresponding to the other plurality of sensors.

14. The storage medium of claim 1, wherein the instructions, when executed, further cause the machine to:
select the plurality of unsupervised anomaly detection machine learning algorithms from a collection of unsupervised anomaly detection machine learning algorithms, wherein the plurality of unsupervised anomaly detection machine learning algorithms comprise a subset of the collection of unsupervised anomaly detection machine learning algorithms.

15. A method comprising:
identifying a collection of data, wherein the collection of data comprises data generated by a plurality of sensors;
generating a set of feature vectors from the collection of data;
executing a plurality of unsupervised anomaly detection machine learning algorithms in an ensemble using the set of feature vectors to generate a set of pseudo labels; and
executing a supervised machine learning algorithm using the set of pseudo labels as training data, to determine an anomaly detection model corresponding to the plurality of sensors.

16. A system comprising:
a data processor device;
computer memory; and
an anomaly detection model generator, executable by the data processor device to:
receive sensor data generated by a plurality of sensors;
determine a plurality of feature vectors from the sensor data;
execute a plurality of unsupervised anomaly detection machine learning algorithms in an ensemble using the plurality of feature vectors to generate a set of predictions;
determine, from the set of predictions, respective entropy-based weightings for each of the plurality of unsupervised anomaly detection machine learning algorithms;
generate a set of pseudo labels based on the predictions and weightings, wherein the set of pseudo labels represents a ground truth; and
execute a supervised machine learning algorithm using the set of pseudo labels as training data, to generate an anomaly detection model corresponding to the plurality of sensors.

17. The system of claim 16, further comprising the plurality of sensors.

18. The system of claim 17, wherein the anomaly detection model generator is further to provide the anomaly detection model to one or more of the plurality of sensors, wherein the one or more of the sensors are to process subsequent sensor data using the anomaly detection model to determine whether the subsequent sensor data comprises one or more anomalies.

19. The system of claim 17, wherein the plurality of sensors comprise a plurality of different types of sensors.

20. The system of claim 16, further comprising a gateway device through which the plurality of sensors communicates on a network, wherein the anomaly detection model generator is further to provide the anomaly detection model to the gateway device, and the gateway device is to process subsequent sensor data received from the plurality of sensors using the anomaly detection model to determine whether the subsequent sensor data comprises one or more anomalies.
